(19) United States
(12) Patent Application Publication
(10) Pub. No.: US 2017/0310828 A1
(43) Pub. Date: Oct. 26, 2017

(54) UTILIZING CLIENT DATA USAGE INFORMATION TO ADJUST BANDWIDTH IN AN ADAPTIVE BIT RATE DEVICE

(71) Applicant: TELEFONAKTIEBOLAGET LM ERICSSON (PUBL), Stockholm (SE)

(72) Inventor: Vishal Changrani, Duluth, GA (US)

(21) Appl. No.: 15/136,515

(22) Filed: Apr. 22, 2016

(51) Int. Cl. H04M 15/00; H04L 12/26; H04W 4/24

(52) U.S. Cl. CPC H04M 15/39; H04W 4/24; H04L 43/0876; H04L 43/16; H04M 15/852

(57) ABSTRACT

An Adaptive Bit Rate (ABR) device and method are described herein for utilizing client data usage information when consuming digital content from an ABR server. In one embodiment, the ABR device is configured to: (i) transmit, to the ABR server, a request for a digital content; (ii) receive, from the ABR server, a manifest associated with the digital content; (iii) select a bit rate from the manifest; (iv) obtain a data threshold (T); (v) obtain data usage information; (vi) compare the data usage information to the data threshold (T); (vii) choose a final bit rate from the manifest based on the comparison result; and (viii) receive, from the ABR server, all segments of the digital content at the final bit rate.

### TECHNICAL FIELD

The present disclosure relates generally to an Adaptive Bit Rate (ABR) device and method for utilizing client data usage information when consuming digital content from an ABR server.

### BACKGROUND

In cellular communication systems, data is provided to mobile ABR devices as part of a mobile service and that data is generally capped or throttled by most mobile providers at a modest level for each customer. Similarly, for wired ABR devices such as cable television set-top boxes, the internet service providers or cable operators also throttle or sometimes cap albeit at a larger limit the data that can be consumed by the wired ABR devices. Since, video consumes a lot of bandwidth it is very likely for a user of a mobile ABR device or wired ABR device to unknowingly exceed the capped limit and thereby incur unwanted data surcharges from their provider in the form of surcharge fees or other penalties. Accordingly, there is a need to address this particular problem and other problems associated with the data usage by a mobile ABR device or a wired ABR device. This need and other needs are satisfied by the present disclosure.

### SUMMARY

An ABR device and method which address the aforementioned problem are described in the independent claims. Advantageous embodiments of the ABR device and method are further described in the dependent claims.

In one aspect, the present disclosure provides an ABR device configured to interact over a network connection with an ABR server. The ABR device comprises a processor and a memory that stores processor-executable instructions, wherein the processor interfaces with the memory to execute the processor-executable instructions, whereby the ABR device is operable to perform a transmit operation, a receive operation, a select operation, a first obtain operation, a second obtain operation, a compare operation, a choose operation, and a consume operation. In the transmit operation, the ABR device transmits a request for a digital content to the ABR server. In the receive operation, the ABR device receives a manifest associated with the digital content from the ABR server. In the select operation, the ABR device selects a bit rate from the manifest. In the first obtain operation, the ABR device obtains a data threshold (T) which relates to a data quota per a billing cycle. In the second obtain operation, the ABR device obtains data usage information which relates to the selected bit rate from the manifest and further relates to data usage that has already occurred during the billing cycle. In the compare operation, the ABR device compares the data usage information to the data threshold (T). In the choose operation, the ABR device chooses a final bit rate from the manifest based on the comparison result. In the consume operation, the ABR device consumes all segments of the digital content at the final bit rate from the ABR server. An advantage of the ABR device implementing these operations is that it helps to protect the user from having to pay for data usage surcharges.

In another aspect, the present disclosure provides a method in an ABR device configured to interact over a network connection with an ABR server. The method comprises a transmitting step, a receiving step, a selecting step, a first obtaining step, a second obtaining step, a comparing step, a choosing step, and a consuming step. In the transmitting step, the ABR device transmits request for a digital content to the ABR server. In the receiving step, the ABR device receives a manifest associated with the digital content from the ABR server. In the selecting step, the ABR device selects a bit rate from the manifest. In the first obtaining step, the ABR device obtains a data threshold (T) which relates to a data quota per a billing cycle. In the second obtaining step, the ABR device obtains data usage information which relates to the selected bit rate from the manifest and further relates to data usage that has already occurred during the billing cycle. In the compare step, the ABR device compares the data usage information to the data threshold (T). In the choosing step, the ABR device chooses a final bit rate from the manifest based on the comparison result. In the consuming step, the ABR device receives all segments of the digital content at the final bit rate from the ABR server. An advantage of the ABR device implementing these steps is that it helps to protect the user of the ABR device from having to pay for data usage surcharges.

Additional aspects of the present disclosure will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the present disclosure.

### BRIEF DESCRIPTION OF THE DRAWINGS

A more complete understanding of the present disclosure may be obtained by reference to the following detailed description when taken in conjunction with the accompanying drawings:

FIG. 1 is a basic diagram of an ABR device that requests and then consumes a particular piece of digital content over a network connection from an ABR server in accordance with an embodiment of the present invention;

FIG. 2 is a flowchart of a method implemented in the ABR device shown in FIG. 1 in accordance with an embodiment of the present disclosure;

FIG. 3 is a block diagram illustrating an exemplary structure of the ABR device configured to implement the method shown in FIG. 2 in accordance with an embodiment of the present disclosure;

FIG. 4 is a basic diagram of an ABR device that requests and then consumes a particular piece of digital content over a network connection from an ABR server in accordance with another embodiment of the present invention;

FIG. 5 is a flowchart of a method implemented in the ABR device shown in FIG. 4 in accordance with another embodiment of the present disclosure;

FIG. 6 is a block diagram illustrating an exemplary structure of the ABR device configured to implement the method shown in FIG. 5 in accordance with another embodiment of the present disclosure; and

FIGS. 7A-7D are several diagrams used to help explain the basics of Hypertext Transfer Protocol (HTTP) Adaptive Bitrate Streaming technology which is used and improved upon by the ABR device of the present disclosure.

### DETAILED DESCRIPTION

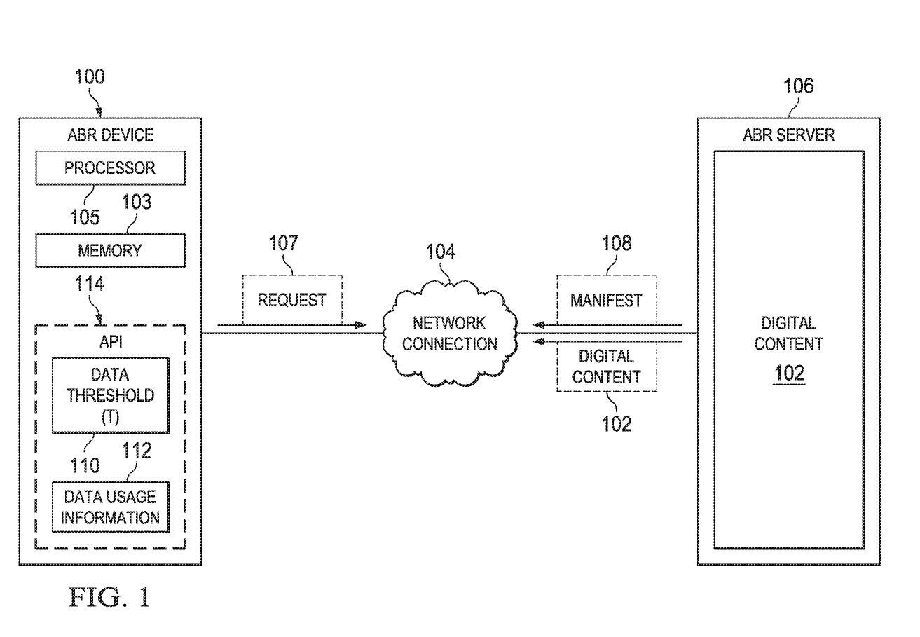

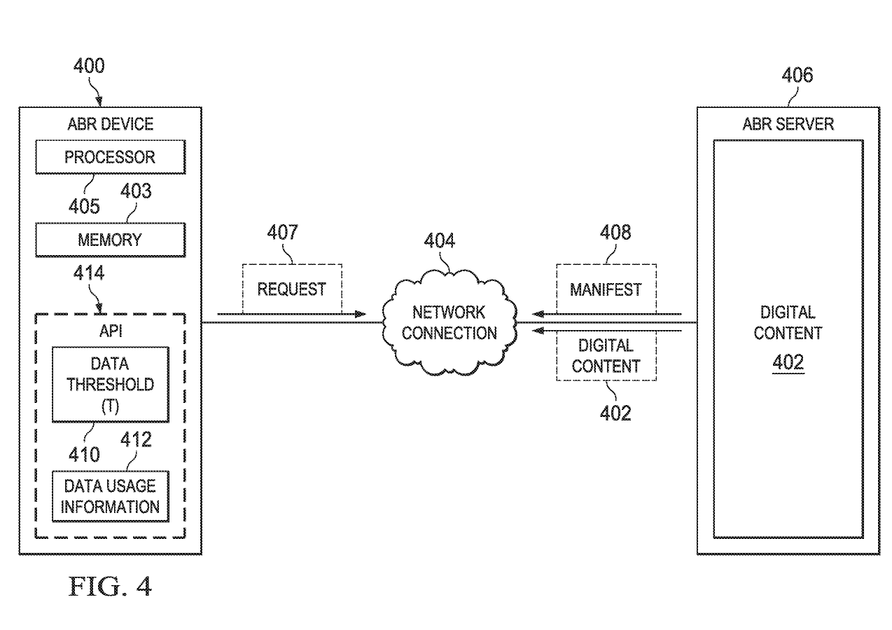

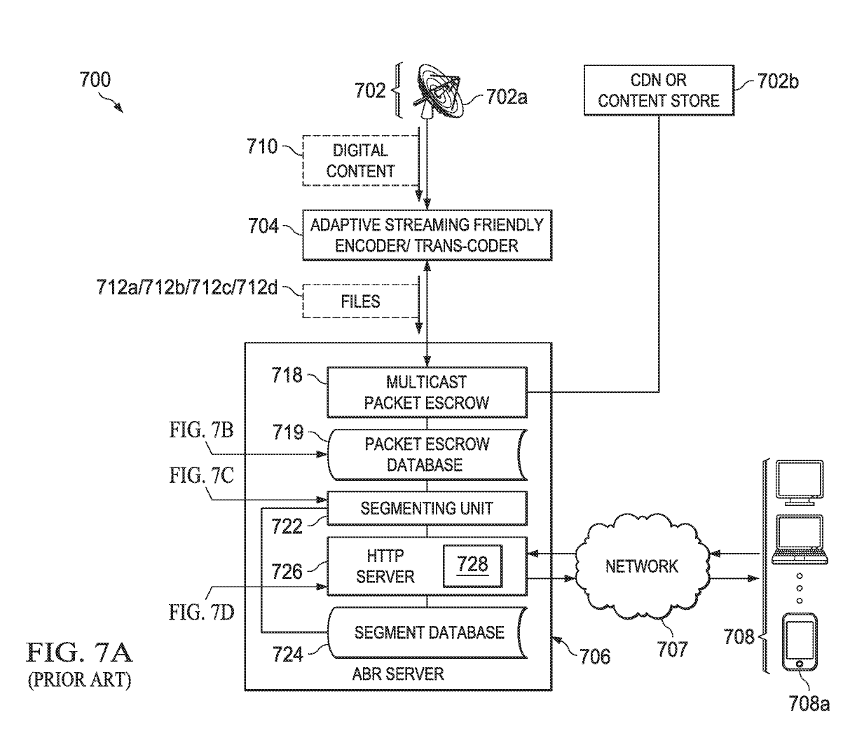

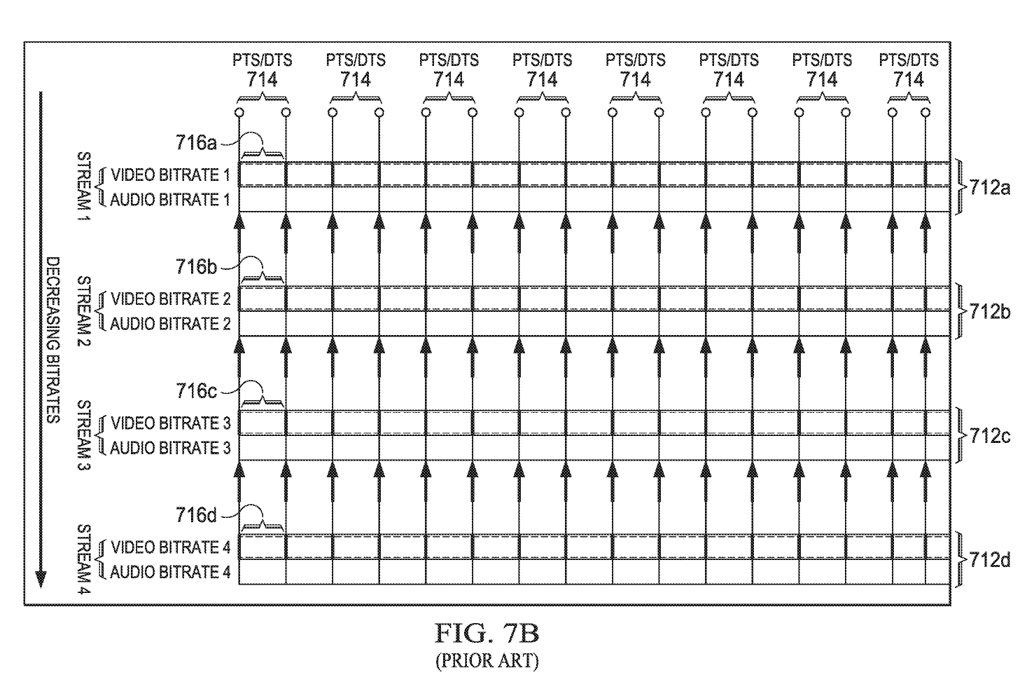

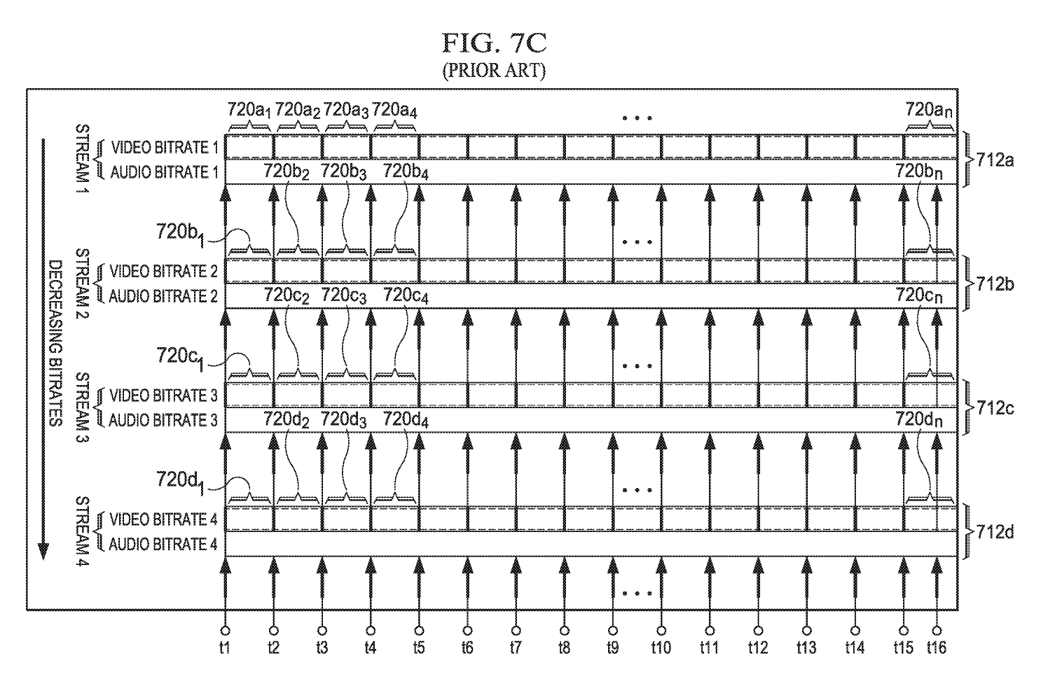

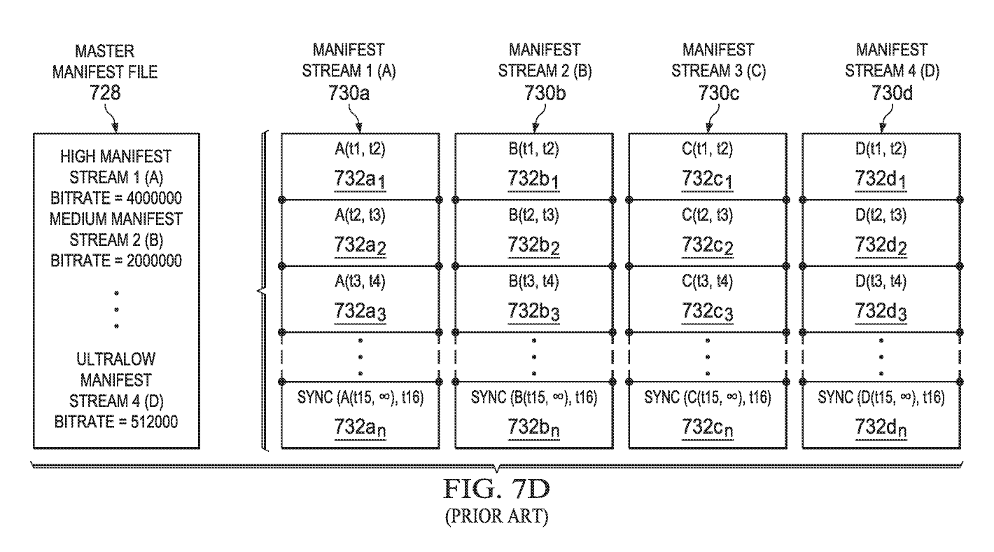

A discussion is provided first herein to describe a general way that an exemplary ABR device (e.g., computer, mobile communication device, tablet, smart phone, IPTV Set Top box, SmartTV) can utilize a data threshold and user data usage information to select a bit rate with which to consume digital content from an ABR server (see FIGS. 1-3). Then, a discussion is provided to describe a more detailed way that an exemplary ABR device (e.g., computer, mobile communication device, tablet, smart phone, IPTV Set Top box, SmartTV) can utilize a data threshold and user data usage information to select a bit rate with which to consume digital content from an ABR server (see FIGS. 4-6). Finally, a basic description is provided about the traditional HTTP ABR streaming technology and how the new ABR device (e.g., computer, mobile communication device, tablet, smart phone, IPTV Set Top box, SmartTV) can improve the HTTP ABR streaming technology in accordance with the present disclosure (see FIGS. 7A-7D).

### General Embodiment: ABR Device 100

Referring to FIG. 1, there is shown a basic diagram of an ABR device 100 (e.g., wired ABR device 100, wireless ABR device 100) that is configured to request and then consume a particular digital content 102 (e.g., movie 102, musical composition 102, application 102, or file 102) over a network connection 104 (e.g., internet connection 104, cable connection 104, wireless connection 104, or satellite connection 104) from an ABR server 106 in accordance with an embodiment of the present invention. Basically, the ABR device 100 is configured to advantageously utilize a data threshold and user data usage information to select a particular bit rate at which to consume the digital content 102 in a manner that helps to protect the user of the ABR device 100 from unnecessary data usage surcharges by the service provider. A discussion is provided next to describe an exemplary method 200 that the ABR device 100 can implement which utilizes a data threshold and user data usage information to select a particular bit rate with which to consume the digital content 102 in accordance with an embodiment of the present invention.

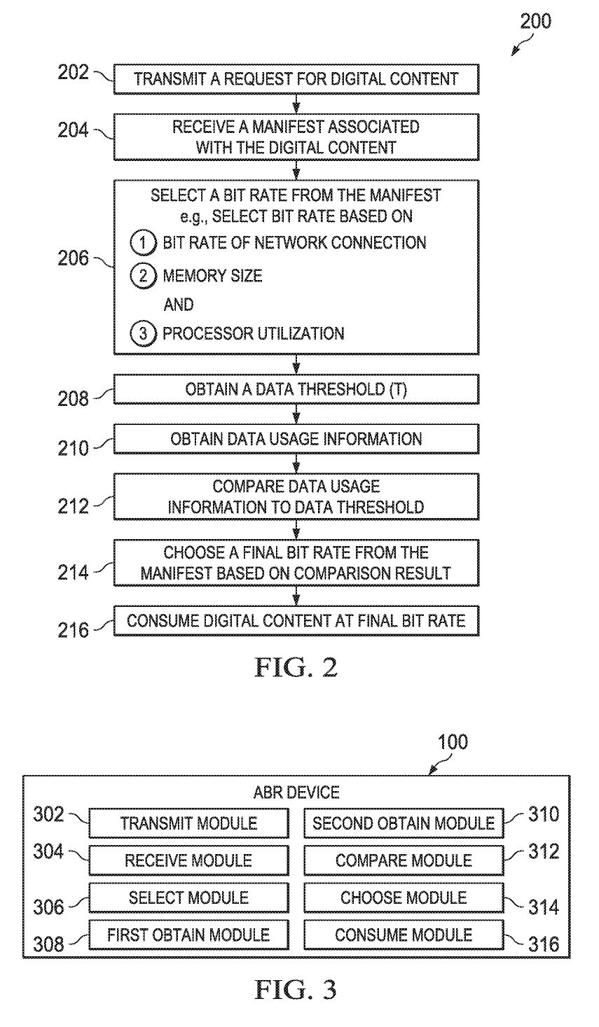

Referring to FIG. 2, there is a flowchart of the exemplary method 200 implemented in the ABR device 100 in accordance with an embodiment of the present disclosure. At step 202, the ABR device 100 transmits a request 107 for a digital content 102 over the network connection 104 to the ABR server 106. At step 204, the ABR device 100 receives a manifest 108 (e.g., manifest file 108) associated with the requested digital content 102 from the ABR server 106 (see discussion regarding HTTP Adaptive Bitrate Streaming technology for details about a manifest file). At step 206, the ABR device 100 selects a bit rate from the manifest 108. For example, the ABR device 100 can select a bit rate from the manifest 108 based on one or more the following: (1) a determined bit rate of the network connection 104; (2) a size of a memory 103 (buffer 103) in the ABR device 100; and (3) a usage of a processor 105 (central processing unit 105) in the ABR device 100. At step 208, the ABR device 100 obtains a data threshold (T) 110 which relates to a data quota provided by a provider per a billing cycle where if this data quota is exceeded then data surcharges are triggered. At step 210, the ABR device 100 obtains data usage information 112 where at least a portion of which of relates to the selected bit rate from the manifest 108 for the requested digital content 102 and another portion of which relates to data usage that has already occurred during the current billing cycle. If desired, the ABR device 100 may have an Application Program Interface (API) 114 that obtains the data threshold (T) 110 and the data usage information 112. Alternatively, the user can input the data threshold (T) 110 and the data usage information 112 into the ABR device 100. At step 212, the ABR device 100 compares the data threshold (T) 110 to the data usage information 112. At step 214, the ABR device 100 chooses a final bit rate from the manifest 108 based on the comparison result of step 212, where the chosen final bit rate can be the previously selected bit rate or a lower bit rate from the manifest 108. The idea being that if possible the chosen final bit rate should help ensure that the data threshold (T) 110 is not exceeded for the current billing cycle so as to help prevent the user from being charged for excessive data usage. At step 216, the ABR device 100 consumes all segments of the digital content 102 at the chosen final bit rate from the ABR server 106. For example, the ABR device 100 can consume the digital content 102 by requesting and receiving the segments of the digital content 102 at the chosen final bit rate and playing the received segments of the digital content 102 for the user of the ABR device 100. The ABR device 100 is a marked improvement over the prior art in that by implementing method 200 it helps to protect the user of the ABR device 100 from having to pay for data usage surcharges.

Referring to FIG. 3, there is a block diagram illustrating structures of the exemplary ABR device 100 configured in accordance with an embodiment of the present disclosure. In one embodiment, the ABR device 100 may comprise a transmit module 302, a receive module 304, a select module 306, a first obtain module 308, a second obtain module 310, a compare module 312, a choose module 314, and a consume module 316. The transmit module 302 is configured to transmit a request 107 for a digital content 102 over the network connection 104 to the ABR server 106. The receive module 304 is configured to receive a manifest 108 (e.g., manifest file 108) associated with the requested digital content 102 from the ABR server 106. The select module 306 is configured to select a bit rate from the manifest 108. For example, the select module 306 can select a bit rate from the manifest 108 based on one or more the following: (1) a determined bit rate of the network connection 104; (2) a size of a memory 103 (buffer 103) in the ABR device 100; and (3) a usage of a processor 105 (central processing unit 105) in the ABR device 100. The first obtain module 308 is configured to obtain a data threshold (T) 110 which relates to a data quota provided by a provider per a billing cycle where if exceeded than data surcharges are triggered. The second obtain module 310 is configured to obtain data usage information 112 where at least a portion of which of relates to the selected bit rate from the manifest 108 for the requested digital content 102 and another portion of which relates to data usage that has already occurred during the current billing cycle. The compare module 312 is configured to compare the data threshold (T) 110 to the data usage information 112. The choose module 314 is configured to choose a final bit rate from the manifest 108 based on the comparison result, where the chosen final bit rate can be the previously selected bit rate or a lower bit rate from the manifest 108. The idea being that if possible the chosen final bit rate should help ensure that the data threshold (T) is not exceeded for the current billing cycle so as to help prevent the user from being charged for excessive data usage. The consume module 316 is configured to consume all segments of the digital content 102 at the chosen final bit rate from the ABR server 106. For example, the consume module 316 can consume the digital content 102 by requesting and receiving the segments of the digital content 102 at the chosen final bit rate and playing the received segments of the digital content 102 for the user of the ABR device 100. Further, the ABR device 100 may also include many other components, modules or structures which are well-known such as a display (for playing the digital content 102), but for clarity, only the components, modules or structures needed to describe the features of the present disclosure are described herein.

As those skilled in the art will appreciate, the above-described modules 302, 304, 306, 308, 310, 312, 314, and 316 of the ABR device 100 may be implemented separately as suitable dedicated circuits. Further, the modules 302, 304, 306, 308, 310, 312, 314, and 316 can also be implemented using any number of dedicated circuits through functional combination or separation. In some embodiments, the modules 302, 304, 306, 308, 310, 312, 314, and 316 may be even combined in a single application specific integrated circuit (ASIC). As an alternative software-based implementation, the ABR device 100 may comprise a memory 103, and a processor 105 (including but not limited to a microprocessor, a microcontroller or a Digital Signal Processor (DSP), etc.). The memory 103 stores machine-readable program code executable by the processor 105 to cause the ABR device 100 to perform the steps of the above-described method 200.

### Specific Embodiment: ABR Device 400

Referring to FIG. 4, there is shown a basic diagram of an ABR device 400 (e.g., wired ABR device 400, wireless ABR device 400) that is configured to request and then consume a particular digital content 402 (e.g., movie 402, musical composition 402, application 402, or file 402) over a network connection 404 (e.g., internet connection 404, cable connection 404, wireless connection 404, or satellite connection 404) from an ABR server 406 in accordance with an embodiment of the present invention. Basically, the ABR device 400 is configured to advantageously utilize a data threshold and user data usage information to select a particular bit rate at which to consume the digital content 402 in a manner that helps to protect the user of the ABR device 400 from unnecessary data usage surcharges by the service provider. A discussion is provided next to describe an exemplary method 500 that the ABR device 400 can implement which utilizes a data threshold and user data usage information to select a particular bit rate with which to consume the digital content 402 in accordance with an embodiment of the present invention.

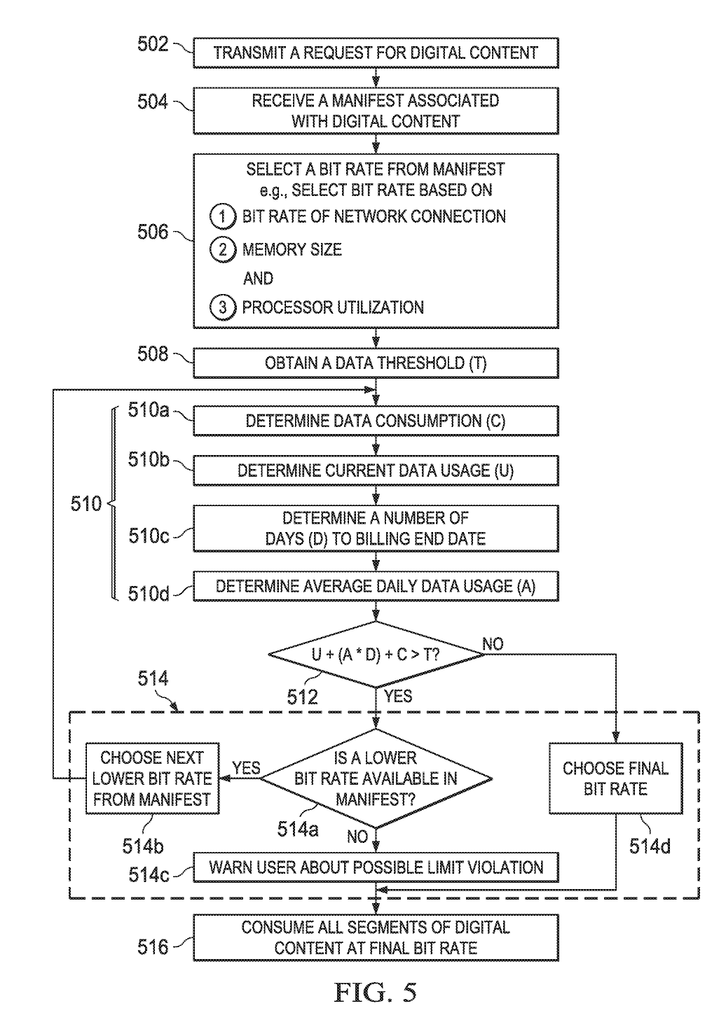

Referring to FIG. 5, there is a flowchart of an exemplary method 500 implemented in the ABR device 400 in accordance with an embodiment of the present disclosure. At step 502, the ABR device 400 transmits a request 407 for a particular digital content 402 over the network connection 404 to the ABR server 406. At step 504, the ABR device 400 receives a manifest 408 (e.g., manifest file 408) associated with the requested digital content 402 from the ABR server 406 (see discussion regarding HTTP Adaptive Bitrate Streaming technology for details about a manifest file). At step 506, the ABR device 400 selects a bit rate from the manifest 408. For example, the ABR device 400 can select a bit rate from the manifest 408 based on one or more the following: (1) a determined bit rate of the network connection 404; (2) a size of a memory 403 (buffer 403) in the ABR device 400; and (3) a usage of a processor 405 (central processing unit 405) in the ABR device 400. At step 508, the ABR device 400 obtains a data threshold (T) 410, where the data threshold (T) 410 can be one of the following: (1) a percentage of a data quota provided by a provider per a billing cycle; or (2) the data quota provided by the provider per the billing cycle. At step 510, the ABR device 400 obtains data usage information 412 as follows: (i) determine a data consumption (C) that will be incurred based on the selected bit rate and a run length of the digital content 402 (step 510a); (ii) determine a current data usage (U) (step 510b); (iii) determine a number of days (D) to a billing end date (step 510c); and (iv) determine an average daily data usage (A) (step 510d). At step 512, the ABR device 400 compares the data threshold (T) 410 to the data usage information 412 per the following formula: U+(A*D)+C>T. At step 514, the ABR device 400 chooses a final bit rate from the manifest 508 based on the comparison result of step 512 as follows: (i) based on the comparison result that the data threshold (T) 410 is exceeded, determine whether there is a lower bit rate in the manifest 508 (step 514a); (ii) based on the determination that there is the lower bit rate in the manifest 508, choose from the manifest 508 a next lower bit rate with respect to the bit rate that was previously used and return to step 510 and utilize the next lower bit rate when determining the data usage information 412 (step 514b); (iii) based on the determination that there is no lower bit rate in the manifest, warn a user of the ABR device 400 about a possible data limit violation (step 514c); and (iv) based on the comparison result that the data threshold (T) is not exceeded, choose the bit rate that was used in the data usage information 412 when performing the comparing step 512 as the final bit rate (step 514d). At step 516, the ABR device 400 consumes all segments of the requested digital content 402 at the chosen final bit rate from the ABR server 406. For example, the ABR device 400 can consume the requested digital content 402 by requesting and receiving the segments of the digital content 402 at the chosen final bit rate and playing the received segments of the digital content 402 for the user of the ABR device 400. The ABR device 400 is a marked improvement over the prior art in that by implementing method 500 it helps to protect the user of the ABR device 400 from having to pay for data usage surcharges.

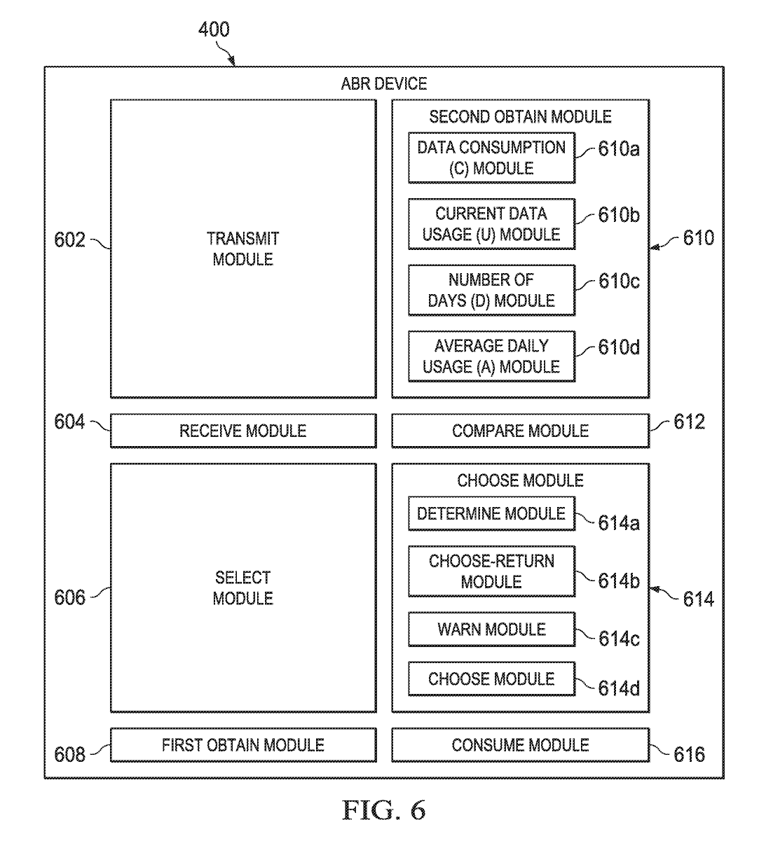

Referring to FIG. 6, there is a block diagram illustrating structures of the exemplary ABR device 400 configured in accordance with an embodiment of the present disclosure. In one embodiment, the ABR device 400 may comprise a transmit module 602, a receive module 604, a select module 606, a first obtain module 608, a second obtain module 610, a compare module 612, a choose module 614, and a consume module 616. The transmit module 602 is configured to transmit a request 407 for a particular digital content 402 over the network connection 404 to the ABR server 406. The receive module 614 is configured to receive a manifest 408 (e.g., manifest file 408) associated with the requested digital content 402 from the ABR server 406. The select module 606 is configured to select a bit rate from the manifest 408. For example, the select module 606 can select a bit rate from the manifest 408 based on one or more the following: (1) a determined bit rate of the network connection 404; (2) a size of a memory 403 (buffer 403) in the ABR device 400; and (3) a usage of a processor 405 (central processing unit 405) in the ABR device 400. The first obtain module 608 is configured to obtain a data threshold (T) 410, where the data threshold (T) 410 can be one of the following: (1) a percentage of a data quota provided by a provider per a billing cycle; or (2) the data quota provided by the provider per the billing cycle. The second obtain module 610 is configured to obtain data usage information 412 as follows: (i) determine a data consumption (C) that will be incurred based on the selected bit rate and a run length of the digital content 402 (data consumption (C) module 610a); (ii) determine a current data usage (U) (current data usage (U) module 610b); (iii) determine a number of days (D) to a billing end date (number of days (D) module 610c); and (iv) determine an average daily data usage (A) (average daily usage (A) module 610d). The compare module 612 is configured to compare the data threshold (T) 410 to the data usage information 412 per the following formula: U+(A*D)+C>T. The choose module 614 is configured to choose a final bit rate from the manifest 508 based on the comparison result as follows: (i) based on the comparison result that the data threshold (T) 410 is exceeded, determine whether there is a lower bit rate in the manifest 508 (determine module 614a); (ii) based on the determination that there is the lower bit rate in the manifest 508, choose from the manifest 508 a next lower bit rate with respect to the bit rate that was previously used and return to step 510 and utilize the next lower bit rate when determining the data usage information (choose-return module 614b); (iii) based on the determination that there is no lower bit rate in the manifest, warn a user of the ABR device 400 about a possible data limit violation (warn module 614c); and (iv) based on the comparison result that the data threshold (T) is not exceeded, choose the bit rate that was used in the data usage information 412 when performing the comparing step 512 as the final bit rate (choose module 614d). The consume module 616 is configured to consume all segments of the requested digital content 402 at the chosen final bit rate from the ABR server 406. Further, the ABR device 400 may also include many other components, modules or structures which are well-known such as a display (for playing the digital content 402), but for clarity, only the components, modules or structures needed to describe the features of the present disclosure are described herein.

As those skilled in the art will appreciate, the above-described modules 602, 604, 606, 608, 610 (including 610a, 610b, 610c, 610d), 612, 614 (including 614a, 614b, 614c, 614d), and 616 of the ABR device 300 may be implemented separately as suitable dedicated circuits. Further, the modules 602, 604, 606, 608, 610 (including 610a, 610b, 610c, 610d), 612, 614 (including 614a, 614b, 614c, 614d), and 616 can also be implemented using any number of dedicated circuits through functional combination or separation. In some embodiments, the modules 602, 604, 606, 608, 610 (including 610a, 610b, 610c, 610d), 612, 614 (including 614a, 614b, 614c, 614d), and 616 may be even combined in a single application specific integrated circuit (ASIC). As an alternative software-based implementation, the ABR device 400 may comprise a memory 403, and a processor 405 (including but not limited to a microprocessor, a microcontroller or a Digital Signal Processor (DSP), etc.). The memory 403 stores machine-readable program code executable by the processor 405 to cause the ABR device 400 to perform the steps of the above-described method 500.

The following are two examples to illustrate how the ABR device 400 can implement method 500 in accordance with an embodiment of the present disclosure.

### Example 1

User A is using the mobile ABR device 400 (e.g., a mobile phone with a specifically configured ABR client) which has so far consumed 1.6 GB of data during the current billing cycle—which this is the last day of the current billing cycle. The data usage quota provided by the provider is 2 GB per billing cycle. User A is at 80% of the data usage quota. User A has set his data threshold (T) at 1.8 GB (step 508).

User A is trying to view a video 402 using his mobile ABR device 100 (step 502). The video 402 is 5 minutes long and is served from the ABR server 406. The ABR manifest 408 informs the ABR device 400 that the segments of the video 402 are available in the following bit rates (step 504):

200 kbps

350 kbps

700 kbps

1500 kbps

2000 kbps

8000 kbps

The currently available bandwidth over the network connection 404 for the mobile ABR device 400 is 2 Mb/s.

Assume the ABR device 400 first chooses to download the segments of the video 402 at 700 kbps after taking into account the buffer 403 size, the available bit rate which in this example is 2 Mb/s, and the processor 405 (CPU 405) utilization (step 506). The ABR device 400 will also execute the following operations:

1. Determine data consumption (C) that will be incurred based on selected bit rate and run length of video 402 as follows: C=700 kbps*5*60=210000 kbits (step 510a).

2. Determine provider data limit: L=2 GB.

3. Determine current data usage: U=1.6 GB (step 510b).

4. Determine days to billing ending date: D=0 since this is the last day of the billing cycle (step 510c).

5. Determine data threshold (T): T=1.8 GB where the user set this threshold based on provider data quota 2 GB (step 508).

6. Determine the user's average daily usage (A): A=60 MB where in this example the user, on an average, consumes 60 MB of data daily (step 510d).

7. Calculate if consuming the video 402 at the selected data rate (700 kbps) will exceed the data threshold (T) using following formula U+(A*D)+C>T (note: this formula is an example other formulas would also be permissible) (step 512):

U+(A*D)+C=1.6 GB+(60 MB*0)+210000 kbits=1810000 kbits T=1.8 GB=1800000 kbits

In this example, U+(A*D)+C>T is true, the current selected data rate 700 kbps is not appropriate.

8. Select the next lower data rate available in manifest 408: 350 kbps (step 514b).

9. Again, calculate if consuming the video 402 at the selected data rate 350 kbps will exceed the data threshold (T):

U+(A*D)+C=1.6 GB+(60 MB*0)+(350 kbps*5*60)=1705000 kbits T=1.8 GB=1800000 kbits

Since U+(A*D)+C>T is false, the current selected data rate 350 kbps is appropriate.

Consuming the video 402 at 350 kbps will not exceed the data threshold (T).

10. Consume all segments of the video 402 corresponding to 350 kbps.

### Example 2

User A is using the mobile ABR device 400 (e.g., a mobile phone with a specifically configured ABR client) which has so far consumed 500 MB of data during the current billing cycle—which this is in the middle of the current billing cycle. The data usage quota provided by the provider is 2 GB per billing cycle. User A is at 25% of the data usage quota. User A has set his data threshold (T) at 1.8 GB (step 508).

User A is trying to view a video 402 using his mobile ABR device 100 (step 502). The video 402 is 10 minutes long and is served from the ABR server 406. The ABR manifest 408 informs the ABR device 400 that the segments of the video 402 are available in the following bit rates (step 504):

200 kbps

350 kbps

700 kbps

1500 kbps

2000 kbps

8000 kbps

The currently available bandwidth over the network connection 404 for the mobile ABR device 400 is 2 Mb/s.

Assume the ABR device 400 first chooses to download the segments of the video 402 at 700 kbps after taking into account the buffer 403 size, the available bit rate which in this example is 2 Mb/s, and the processor 405 (CPU 405) utilization (step 506). The ABR device 400 will also execute the following operations:

1. Determine data consumption (C) that will be incurred based on selected bit rate and run length of video 402 as follows: C=700 kbps*10*60=420000 kbits (step 510a).

2. Determine provider data limit: L=2 GB.

3. Determine current data usage: U=500 MB (step 510b).

4. Determine days to billing ending date: D=15 since this day is the middle of the billing cycle which in this example is 30 days (step 510c).

5. Determine data threshold (T): T=1.8 GB where the user set this threshold based on provider data quota 2 GB (step 508).

6. Determine the user's average daily usage (A): A=60 MB where in this example the user, on an average, consumes 60 MB of data daily (step 510d).

7. Calculate if consuming the video 402 at the selected data rate (700 kbps) will exceed the data threshold (T) using following formula U+(A*D)+C>T (note: this formula is an example other formulas would also be permissible) (step 512):

U+(A*D)+C=500 MB+(60 MB*15)+420000 kbits=1820000 kbits T=1.8 GB=1800000 kbits

In this example, U+(A*D)+C>T is true, the current selected data rate 700 kbps is not appropriate.

8. Select the next lower data rate available in manifest 408: 350 kbps (step 514b).

9. Again, calculate if consuming the video 402 at the selected data rate 350 kbps will exceed the data threshold (T):

U+(A*D)+C=500 MB+(60 MB*15)+(350 kbps*10*60)=1610000 kbits T=1.8 GB=1800000 kbits

Since U+(A*D)+C>T is false, the current selected data rate 350 kbps is appropriate.

Consuming the video 402 at 350 kbps will not exceed the data threshold (T).

10. Consume all segments of the video 402 corresponding to 350 kbps.

In the aforementioned examples, it is assumed that the data usage statistics 112 (e.g., elements C, U, A and D) and the data limit of the provider can be obtained by an application program interface 414 (API 414) in the ABR device 400. This is a reasonable assumption since most modern ABR devices 400 (wired and wireless) already provide a mature API 414 which could be re-configured to query data usage and data limits. If an API 414 is not available, then user input can be a fall back option.

### Traditional HTTP ABR Streaming Technology and Improvements Thereto

Adaptive bitrate streaming is a technique used by an ABR server for streaming digital content (e.g., a movie, a musical composition, an application, or a file) over one or more networks to an ABR device (e.g., computer, mobile communication device, tablet, smart phone, IPTV Set Top box, SmartTV). In the past, most video streaming technologies utilized streaming protocols such as the Real-Time Transport Protocol (RTP) and the Real-Time Streaming Protocol (RTSP). However, today's adaptive streaming technologies are mostly based on Hypertext Transfer Protocol (HTTP) and are designed to work efficiently over large distributed HTTP networks such as the Internet.

HTTP adaptive bitrate streaming requires that the ABR server have multiple files of the content stream (source video, multimedia) which are encoded at different bitrates. The ABR server then switches between streaming the different encodings of the content file based on requests received from the user's device. The result of the HTTP stream is that the user's device experiences very little buffering and a fast start time so the user has a good experience for both high-end and low-end network connections. Today, there are several HTTP adaptive bitrate streaming technologies that can be used by an ABR server for streaming digital content over networks such as the Internet to ABR devices. For example, Apple's HTTP Live Stream (HLS) m3u8 file system is one such HTTP adaptive bitrate streaming technology where a “manifest” file is created to reference many video segments which are updated in real time to play in a particular order. Other HTTP adaptive bitrate streaming technologies include Adobe's Dynamic stream for Flash, Microsoft's Smooth Streaming etc. . . . .

Referring to FIGS. 7A-7D (PRIOR ART), there several diagrams used to help explain how a traditional system 700 including an ABR server 706 can use HTTP adaptive bitrate streaming technology to provide digital content to one or more ABR devices 508. As shown in FIG. 7A (PRIOR ART), the traditional system 700 includes a content provider 702 (e.g., a broadcast network 702a, CDN/content store 702b), an adaptive streaming encoder/transcoder 704, the ABR server 706, a network 707 (e.g., IP network 707, CDN network 707), and ABR devices 708. The ABR server 706 receives a request from a particular ABR device 708a (for example) for digital content 710 and then retrieves the digital content 710 from the content provider 702. In this example, the broadcast network 702a has the requested digital content 710 and provides the digital content 710 to the adaptive streaming encoder/transcoder 704. The adaptive streaming encoder/transcoder 704 takes the digital content 710 and generates multiple files 712a, 712b, 712c and 712d (for example) of the same video and audio content but which are encoded at different bitrates. For example, the adaptive streaming encoder/transcoder 704 can output a 4M bitrate file 712a, a 2M bitrate file 712b, a 1M bitrate file 712c and a 512K bitrate file 712d which are all key framed aligned with one another by Presentation Timestamp/Display Timestamp (PTSs/DTSs) 714 (see FIG. 7B (PRIOR ART)). Thus, the 4M bitrate file 712a has a section 716a which contains the same video and audio content as the corresponding sections 716b, 716c and 716d of the 2M bitrate file 712b, the 1M bitrate file 712c and the 512K bitrate file 712d. However, the 4M bitrate file's section 716a has a higher quality than the 2M bitrate file's section 716b which has a higher quality than the 1M bitrate file's section 716c which in turn has a higher quality than the 512K bitrate file's section 716d. The ABR server 706 includes a multicast packet escrow 718 which receives the multiple files 712a, 712b, 712c and 712d and a packet escrow database 719 which stores the multiple files 712a, 712b, 712c and 712d. The ABR server 706 includes a segmenting unit 722 which functions to segment each of the stored files 712a, 722b, 712c, and 712d into multiple segment files 720a₁₋ₙ, 720b₁, 720c₁₋ₙ, and 720d₁₋ₙ, (see FIG. 7C (PRIOR ART)). The ABR server 706 includes a segment database 724 which stores the segment files 720a₁, 720b₁, 720c₁, and 720d₁₋ₙ. Each segment file 720a₁₋ₙ, 720b₁₋ₙ, 720c₁₋ₙ, and 720d₁₋ₙ, contains video and audio packets for a predetermined time duration (e.g., 10 seconds). In this example, the segment files 720a₁, 720b₁, 720c₁, and 720d₁ (for example) would be associated with time codes t1-t2 and segment files 720a₄, 720b₄, 720c₄, and 720d₄ (for example) would be associated with time codes t4-t5.

The ABR server 706 has a HTTP server 726 which interfaces with the segment database 724 and creates a master manifest file 728 which includes child manifest files 730a, 730b, 730c and 730d (for example)(see FIG. 7D (PRIOR ART)). Each child manifest file 730a, 730b, 730c and 730d respectively includes references 732a₁₋ₙ, 732b₁₋ₙ, 732c₁₋ₙ, and 732d₁₋ₙ to each of the segment files 720a₁₋ₙ, 720b₁₋ₙ, 720c₁₋ₙ, and 720d₁₋ₙ. The HTTP server 726 sends the master manifest file 728 through the network 707 to ABR device 708a. Thereafter, the ABR device 708a sends a request including one of the child manifest file's reference 732a₁ (for example) through the network 707 to the HTTP server 726. The HTTP server 726 uses the requested reference 732a₁ to retrieve and send the corresponding segment file 720a₁ through the network 707 to the client 708a which plays the segment file 720a₁. The ABR device 708a sends another request identifying one of the child manifest file's reference 732b₂ (for example) through the network 707 to the HTTP server 726. The HTTP server 726 uses the requested references 732b₂ to retrieve and send the corresponding segment file 720b₂ through the network 707 to the ABR device 708a which playbacks the segment file 720b₂. The ABR device 708a continues to send requests for specific segment files 720a₃₋ₙ, 720b₃₋ₙ, 720c₃₋ₙ, and 720d₃₋ₙ (for example) and the HTTP server 726 sends the requested segment files 720a₃₋ₙ, 720b₃₋ₙ, 720c₃₋ₙ, and 720d₃₋ₙ back to the ABR device 708a which playbacks the received segment files 720a₃₋ₙ, 720b₃₋ₙ, 720c₃₋ₙ, and 720d₃₋ₙ. In this way, the ABR device 708a is able to playback the requested digital content 710 while experiencing very little buffering and a fast start time so the user of the ABR device 708a has a good experience for both high-end and low-end network connections.

In view of the foregoing discussion about the new ABR device 100 and 400, one skilled in the art will readily appreciate that the aforementioned traditional ABR device 708a can be re-configured to utilize a data threshold (T) 110 and 410 and client data usage information 112 and 412 to select a bit rate with which to consume digital content 710 from the ABR server 706. The advantage of re-configuring the traditional ABR device 708a in this manner is that it that helps to protect the user of the re-configured ABR device 708a from having to pay for data usage surcharges.

Those skilled in the art will appreciate that the use of the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Of course, the present disclosure may be carried out in other specific ways than those herein set forth without departing from the scope and essential characteristics of the invention. One or more of the specific processes discussed above may be carried out in a cellular phone or other communications transceiver comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that as has been set forth and defined within the following claims.

1. An adaptive bit rate (ABR) device configured to interact over a network connection with an ABR server, the ABR device comprising:
a processor; and,
a memory that stores processor-executable instructions, wherein the processor interfaces with the memory to execute the processor-executable instructions, whereby the ABR device is operable to:
transmit, to the ABR server, a request for a digital content;
receive, from the ABR server, a manifest associated with the digital content;
select a bit rate from the manifest;
obtain a data threshold (T), wherein the data threshold (T) relates to a data quota per a billing cycle;
obtain data usage information, wherein the data usage information relates to the selected bit rate from the manifest and further relates to data usage that has already occurred during the billing cycle;
compare the data usage information to the data threshold (T);
choose a final bit rate from the manifest based on the comparison result; and
receive, from the ABR server, all segments of the digital content at the final bit rate.

2. The ABR device of claim 1, wherein the ABR device is further operable to obtain the data usage information as follows:
determine a data consumption (C) that will be incurred based on the selected bit rate and a run length of the digital content;
determine a current data usage (U);
determine a number of days (D) to an end date of the billing cycle; and
determine an average daily data usage (A).

3. The ABR device of claim 2, wherein the ABR device is further operable to perform the compare operation per the following formula: U+(A*D)+C>T.

4. The ABR device of claim 3, wherein the ABR device is further operable to perform the choose operation as follows:
based on the comparison result that the data threshold (T) is exceeded, determine whether there is a lower bit rate in the manifest;
based on the determination that there is the lower bit rate in the manifest, choose from the manifest a next lower bit rate with respect to the bit rate that was used previously in the obtain data usage operation and return the obtain data usage information operation and utilize the next lower bit rate when determining the data usage information; and
based on the determination that there is no lower bit rate in the manifest, warn a user of the ABR device about a possible data limit violation;
based on the comparison result that the data threshold (T) is not exceeded, choose the bit rate that was used in the data usage information when performing the comparing operation as the final bit rate.

5. The ABR device of claim 1, wherein the ABR device is further operable to select the bit rate from the manifest based on at least the following: (1) a determined bit rate of the network connection; (2) a size of a buffer in the ABR device; and (3) a usage of a central processing unit (CPU) in the ABR device.

6. The ABR device of claim 1, wherein the data threshold (T) is one of the following: (1) a percentage of a data quota provided by a provider per a billing cycle; or (2) the data quota provided by the provider per the billing cycle.

7. The ABR device of claim 1, further comprising:
an Application Program Interface (API) that obtains one or more of the data threshold (T) and the data usage information.

8. The ABR device of claim 1, wherein the ABR device is one of following: a wired ABR device or a wireless ABR device.

9. The ABR device of claim 1, wherein the network connection is one of following: an internet connection, a cable connection, a wireless connection, or a satellite connection.

10. The ABR device of claim 1, wherein the selected digital content is one of a movie, a musical composition, an application, or a file.

11. A method in an adaptive bit rate (ABR) device configured to interact over a network connection with an ABR server, the method comprising:
transmitting, to the ABR server, a request for a digital content;
receiving, from the ABR server, a manifest associated with the digital content;
selecting a bit rate from the manifest;
obtaining a data threshold (T), wherein the data threshold (T) relates to a data quota per a billing cycle;
obtaining data usage information, wherein the data usage information relates to the selected bit rate from the manifest and further relates to data usage that has already occurred during the billing cycle;
comparing the data usage information to the data threshold (T);
choosing a final bit rate from the manifest based on the comparison result; and
receiving, from the ABR server, all segments of the digital content at the final bit rate.

12. The method of claim 11, wherein the obtaining the data usage information further comprises:
determining a data consumption (C) that will be incurred based on the selected bit rate and a run length of the digital content;
determining a current data usage (U);
determining a number of days (D) to an end date of the billing cycle; and
determining an average daily data usage (A).

13. The method of claim 12, wherein the comparing operation is performed per the following formula: U+(A*D)+C>T.

14. The method of claim 13, wherein the choose operation further comprises:
based on the comparison result that the data threshold (T) is exceeded, determining whether there is a lower bit rate in the manifest;
based on the determination that there is the lower bit rate in the manifest, choosing from the manifest a next lower bit rate with respect to the bit rate that was used previously in the obtain data usage operation and return the obtain data usage information operation and utilize the next lower bit rate when determining the data usage information; and
based on the determination that there is no lower bit rate in the manifest, warning a user of the ABR device about a possible data limit violation;
based on the comparison result that the data threshold (T) is not exceeded, choosing the bit rate that was used in the data usage information when performing the comparing step as the final bit rate.

15. The method of claim 11, wherein the selecting operation is based on at least the following: (1) a determined bit rate of the network connection; (2) a size of a buffer in the ABR device; and (3) a usage of a central processing unit (CPU) in the ABR device.

16. The method of claim 11, wherein the data threshold (T) is one of the following: (1) a percentage of a data quota provided by a provider per a billing cycle; or (2) the data quota provided by the provider per the billing cycle.

17. The method of claim 11, wherein the ABR device further comprising:
an Application Program Interface (API) that obtains one or more of the data threshold (T) and the data usage information.

18. The method of claim 11, wherein the ABR device is one of following: a wired ABR device or a wireless ABR device.

19. The method of claim 11, wherein the network connection is one of following: an internet connection, a cable connection, a wireless connection, or a satellite connection.

20. The method of claim 11, wherein the selected digital content is one of a movie, a musical composition, an application, or a file.
